(19) United States
(12) Patent Application Publication
(10) Pub. No.: US 2008/0180433 A1
(43) Pub. Date: Jul. 31, 2008

(54) IMAGE PROCESSING APPARATUS, IMAGE PROCESSING METHOD, AND STORAGE MEDIUM

(75) Inventor: Hiroshi Nakamoto, Yokosuka-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/018,117

(22) Filed: Jan. 22, 2008

(30) Foreign Application Priority Data
Jan. 31, 2007 (JP) 2007-022239

(51) Int. Cl. G06F 17/00

(52) U.S. Cl. 345/418

(57) ABSTRACT

Some embodiments of the present invention provide an image processing apparatus which causes a display device to display image data, the apparatus comprising: an image selection unit configured to select image data displayed in an image selection area in a first arbitrary order; a layout position selection unit configured to select layout positions displayed in a layout area in a second arbitrary order; a determination unit configured to determine layout positions of the image data in the layout area based at least in part upon the first arbitrary order and the second arbitrary order and a display control unit configured to control to display the image data selected by the image selection unit at the layout positions determined by the determination unit on the display device.

### BACKGROUND OF THE INVENTION

1. Field of the Invention

The present invention relates to an image processing apparatus, image processing method, and storage medium which are suitably used to edit and display objects such as a plurality of images.

2. Description of the Related Art

Conventional electronic album editing application software replaces one image data arranged in an electronic album by dragging and dropping one image data outside the electronic album. This makes it possible to replace one image data arranged on the electronic album by one image data outside the electronic album.

In addition, as proposed by Japanese Patent Laid-Open No. 2000-082128, there is known a technique of allowing a user to select a desired image from image data captured in a client computer and arrange the selected image at a desired position on the electronic album.

Assume that in the use of electronic album editing application software, the user must replace many image data during editing. In order to perform this operation, it is necessary to drag and drop image data to replace image data under editing by the number of times equal to the number of image data to be replaced.

In addition, when the user is to replace image data having undergone a frame process, rotation process, trimming process, and the like, he/she drags and drops desired image data onto image data to be replaced. However, the frame process, rotation process, trimming process, and the like applied to the image data before replacement are not reflected in the image data after replacement. For this reason, the user needs to perform a frame process, rotation process, trimming process, and the like for the image data obtained after the image data replacing process.

In order to arrange a plurality of image data in an area, of the editing display area of the electronic album, in which no image data are arranged, the user drags and drops the image data, which he/she wants to arrange, at desired positions. Subsequently, the user must adjust the sizes and the like of the image data to be displayed on the editing display area and perform necessary image processing.

For the above reason, the editing operation of performing a replacement process with respect to a plurality of image data will impose a further burden on a user who is not familiar with the operation of a graphical user interface. The user becomes reluctant to perform editing operation.

### SUMMARY OF THE INVENTION

Embodiments of the present invention have been made to solve the above problems, and have as an object to implement a replacement process with simple operation with respect to objects such as a plurality of images when editing them.

In order to solve the above problem and achieve the object, according to the first aspect of the present invention, there is provided an image processing apparatus which causes a display device to display image data, the apparatus comprising: an image selection unit configured to select image data displayed in an image selection area in a first arbitrary order; a layout position selection unit configured to select layout positions displayed in a layout area in a second arbitrary order; a determination unit configured to determine layout positions of the image data in the layout area based at least in part upon the first arbitrary order and the second arbitrary order and a display control unit configured to control to display the image data selected by the image selection unit at the layout positions determined by the determination unit on the display device.

According to the second aspect of the present invention, there is provided an image processing method which causes a display device to display image data, the method comprising: selecting image data displayed in an image selection area in a first arbitrary order; selecting layout positions displayed in a layout area in a second arbitrary order; determining layout positions of the image data in the layout area based at least in part upon the first arbitrary order and the second arbitrary order; and controlling to display on the display device the image data selected in the selecting the image data step at the layout positions determined in the determining step.

Further features of the present invention will become apparent from the following description of exemplary embodiments with reference to the attached drawings.

### BRIEF DESCRIPTION OF THE DRAWINGS

FIG. 1 is a view showing an example of the arrangement of an image processing system using an image processing apparatus according to an embodiment of the present invention;

FIG. 2 is a block diagram showing an example of the hardware arrangement of the image processing according to an embodiment of the present invention;

FIG. 3 is a view showing the allocations of functions and storage areas which the image processing apparatus according to an embodiment of the present invention;

FIGS. 4A, 4B, and 4C are views each showing an example of an information management table used in the image processing apparatus according to an embodiment of the present invention;

FIG. 5 is a flowchart for explaining an example of the operation of the image processing apparatus according to the first embodiment of the present invention;

FIG. 6 is a flowchart for explaining an example of the operation of an image processing apparatus according to the second embodiment of the present invention;

FIGS. 7A and 7B are views each showing a display example of an image data replacement editing window used in the image processing apparatus according to the first embodiment of the present invention;

FIGS. 8A and 8B are views each showing a display example of an image data replacement editing window used in the image processing apparatus according to the second embodiment of the present invention;

FIGS. 9A and 9B are views each showing a display example of an image data replacement editing window used in an image processing apparatus according to the third embodiment of the present invention;

FIGS. 10A and 10B are views each showing a display example of an image data replacement editing window used in an image processing apparatus according to the fourth embodiment of the present invention; and

FIG. 11 is a flowchart for explaining an example of the operation of the image processing apparatus according to the third embodiment of the present invention.

### DESCRIPTION OF THE EMBODIMENTS

An image processing apparatus according to an embodiment of the present invention will be described next with reference to the accompanying drawings.

### First Embodiment

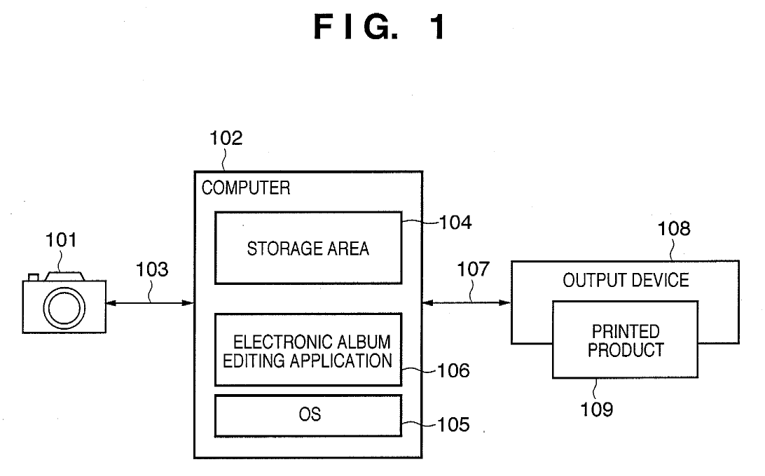

FIG. 1 is a view showing an example of the schematic arrangement of an image processing system using an image processing apparatus according to the first embodiment of the present invention. Referring to FIG. 1, an image input device 101 is an electronic device which converts an optical image as image information into an electrical signal, obtains image data by performing predetermined image processing for the electrical signal, and records and plays back the image data having undergone the image processing.

As the image input device 101, it is possible to use, for example, a digital still camera which captures an object and records the captured object as still image data and a digital video camera which stores a captured object as moving image data. Obviously, it is also possible to use a scanner or the like which reads a sheet original and outputs the read contents of the sheet original as still image data.

A data transfer interface cable 103 is an interface cable for transferring the image data generated by the image input device 101 to a client computer 102. As the data transfer interface cable 103, for example, a wired interface cable typified by a USB (Universal Serial Bus) or IEEE1394 is used. Obviously, it is possible to use a wireless interface typified by IrDA (Infrared Data Association) or Bluetooth® or the like.

The computer 102 performs processing such as creating an electronic album by editing the image data transferred from the image input device 101 via the data transfer interface cable 103.

The image data transferred from the image input device 101 via the data transfer interface cable 103 is stored in a storage area 104 of a memory which the computer 102 includes. As the storage area 104, for example, a hard disk drive (HDD) forming the memory is set. Note that image data is transferred after, for example, the computer 102 secures the storage area 104 in the memory in accordance with a transfer command issued from the image input device 101 to the computer 102.

The CPU of the computer 102 reads out image data stored in the storage area 104 of the memory by executing an electronic album editing application 106 under the control of an installed operating system (OS) 105.

The user creates an electronic album by editing the image data stored in the storage area 104 using the electronic album editing application 106 in the computer 102. A method of creating an electronic album will be described in detail later. Subsequently, the computer 102 stores the created electronic album, transmits it to an output device 108, or prints it as a printed product 109.

A data transfer interface cable 107 is an interface cable for transferring data such as the electronic album created by the computer 102 to the output device 108. As the data transfer interface cable 107, for example, a wired interface cable typified by a USB (Universal Serial Bus) or IEEE1394 is used. It is, however, possible to implement the function of the data transfer interface cable 107 by using a wireless interface typified by IrDA (Infrared Data Association) or Bluetooth®. The output device 108 is, for example, a printer. The output device 108 prints and outputs the printed product 109 of the data of the electronic album created under the control of the computer 102.

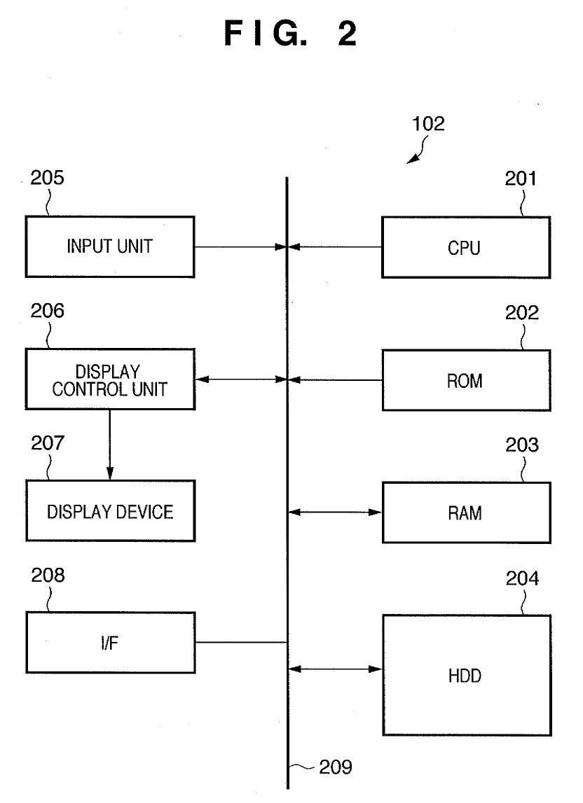

FIG. 2 is a block diagram showing the internal arrangement of the computer 102 forming the image processing apparatus according to an embodiment of the present invention. Referring to FIG. 2, reference numeral 201 denotes a CPU which performs overall control on the computer 102; 202, a ROM which stores a BIOS and a boot program; 203, a RAM which is used as a work area for the CPU 201; 204, a hard disk drive (HDD) which can store an OS, an electronic album editing application used by the image processing apparatus according to an embodiment of the present invention, and various types of data files; and 205, an input unit including a keyboard and a pointing device such as a mouse.

Reference numeral 206 denotes a display control unit comprising a controller which incorporates a video memory and performs a rendering process into the video memory and outputs the rendered data as a video signal; and 207, a display device comprising a CRT, LCD panel, or the like. Note that the display device may be integrated with the image processing apparatus according to this embodiment or may be separated from it and connected to it via a cable or the like.

Reference numeral 208 denotes an interface which can perform two-way communication with the image input device 101 such as a digital camera and the output device 108 such as a printer. The data transfer interface cables 103 and 107 are connected to the interface 208. The respective blocks are connected via an internal bus 209 to exchange control signals, data, and the like.

In the operation of the image processing apparatus according to this embodiment described above, when the power supply of the computer 102 is turned on, the CPU 201 executes the boot program stored in the ROM 202, and starts loading the OS from the HDD 204 into the RAM 203. Thereafter, various types of application programs are loaded into the RAM 203 to perform the respective processes.

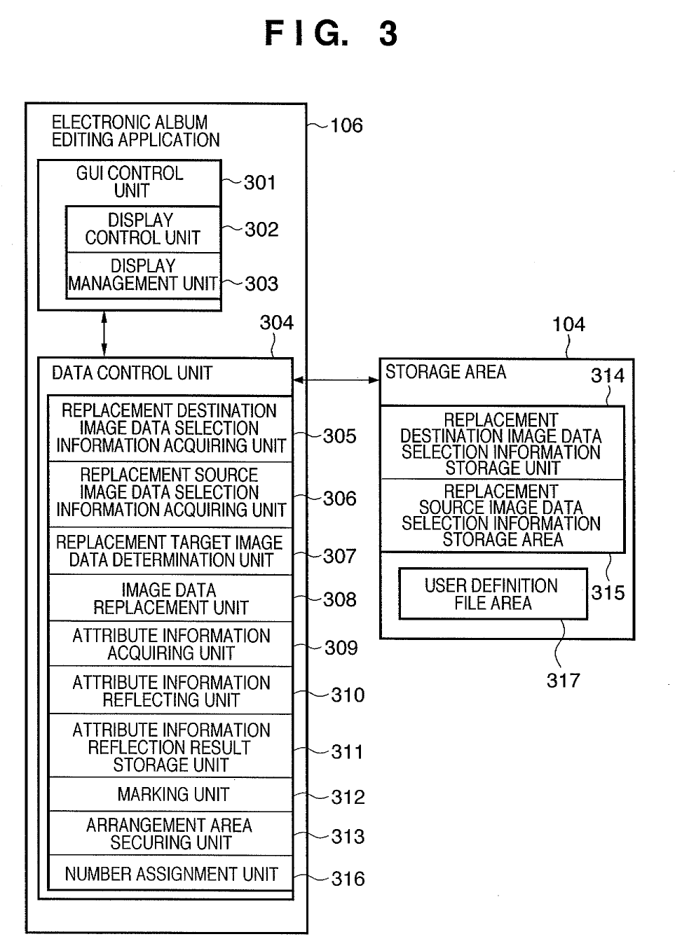

FIG. 3 is a view showing an example of the arrangement of the functions of the electronic album editing application 106 in the computer 102 which is the image processing apparatus according to this embodiment and an example of the arrangement of the respective areas in the storage area 104.

Referring to FIG. 3, a data control unit 304 includes a replacement destination image data selection information acquiring unit 305, replacement source image data selection information acquiring unit 306, and replacement target image data determination unit 307. The data control unit 304 further includes an image data replacement unit 308, attribute information acquiring unit 309, attribute information reflecting unit 310, attribute information reflection result storage unit 311, marking unit 312, replacement area securing unit 313, and number assignment unit 316.

The CPU 201 executes the processing of replacing image data in the electronic album by executing the data control unit 304 including these units.

A GUI control unit 301 includes a display control unit 302 and a display management unit 303, as shown in FIG. 3. The GUI control unit 301 displays a graphical user interface (to be referred to as a GUI hereinafter) necessary for the execution of a replacement process for image data in the electronic album. The contents of operation by the user with the input unit 205 in accordance with a GUI window are output to the data control unit 304.

The storage area 104 includes a replacement destination image data selection information storage unit 314 which is an area for storing the information acquired by the replacement destination image data selection information acquiring unit 305 and attribute information acquiring unit 309 of the data control unit 304. The storage area 104 includes a replacement source image data selection information storage area 315 which is an area for storing the information acquired by the replacement source image data selection information acquiring unit 306 and the attribute information acquiring unit 309. The storage area 104 also includes a user definition file area 317 which is an area for storing the values set in advance by the user with respect to editing operation in the electronic album.

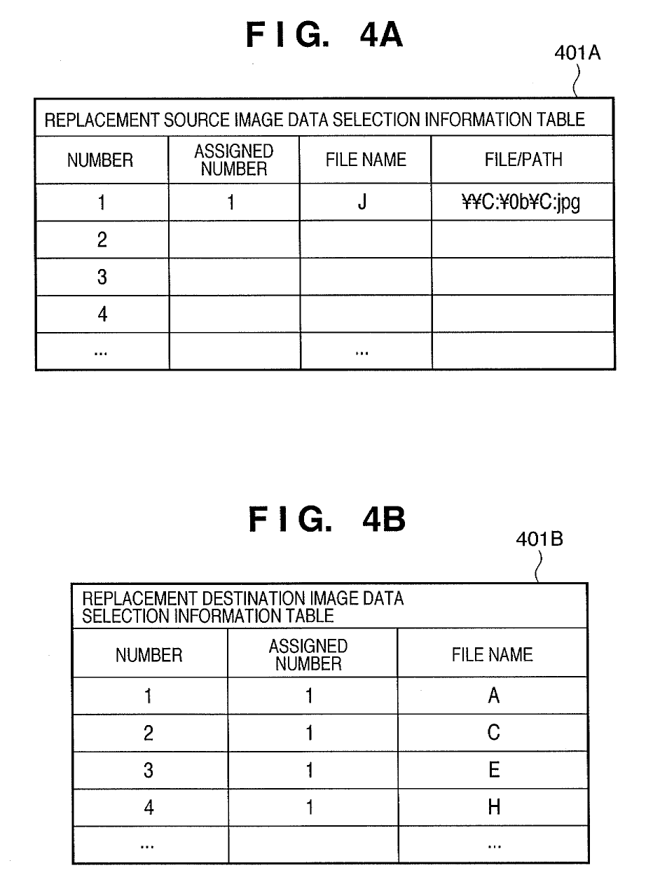

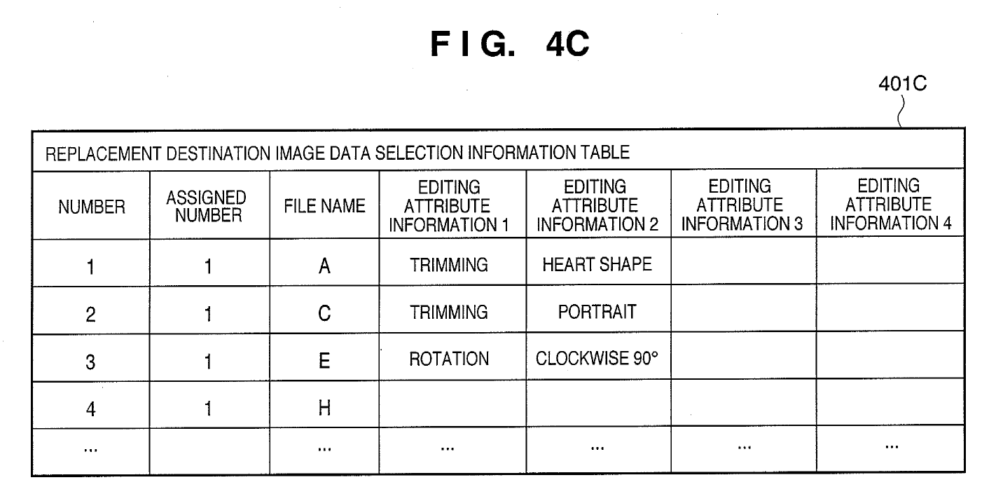

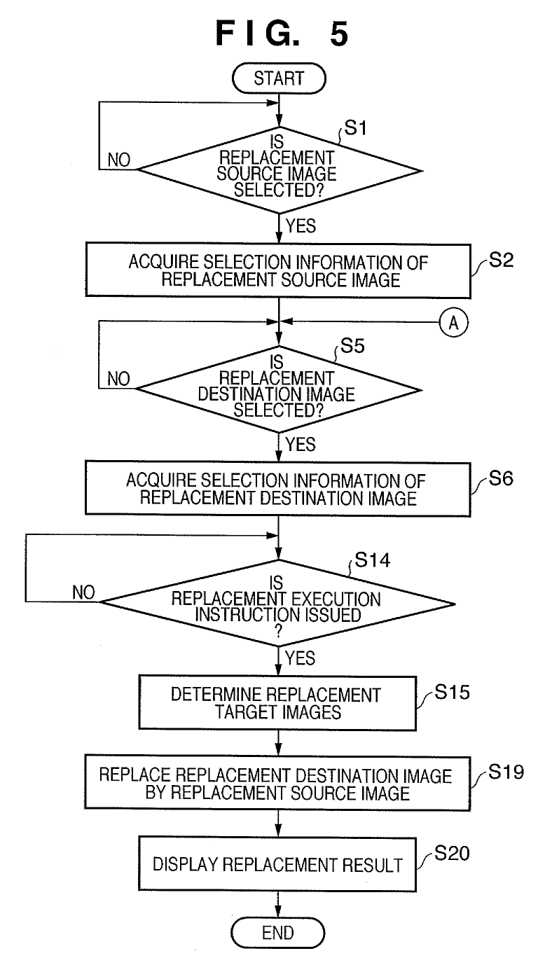

In the replacement source image data selection information storage area 315, information is managed as a replacement source image data selection information table 401A, as shown in FIG. 4A. The replacement source image data selection information table 401A represents a state in which image data with file name “J” is managed at the first position. More specifically, the information to be managed includes a number representing the order in which the image is selected in the replacement source image data display area, an assigned number, a file name representing the file name of the selected image data, and a file path representing the storage position of the image data.

As shown in FIGS. 4B and 4C, in the replacement destination image data selection information storage unit 314, various types of information are managed as replacement destination image data selection information tables 401B and 401C. More specifically, the information to be managed includes a number representing the order in which the image is selected in the album editing area, an assigned number, and a file name representing the file name of the selected image data. FIG. 4B shows a state wherein image data with file names “A”, “C”, “E”, and “H” are managed at the first, second, third, and fourth positions, respectively. Assume that a file name can uniquely specify image data in an electronic album.

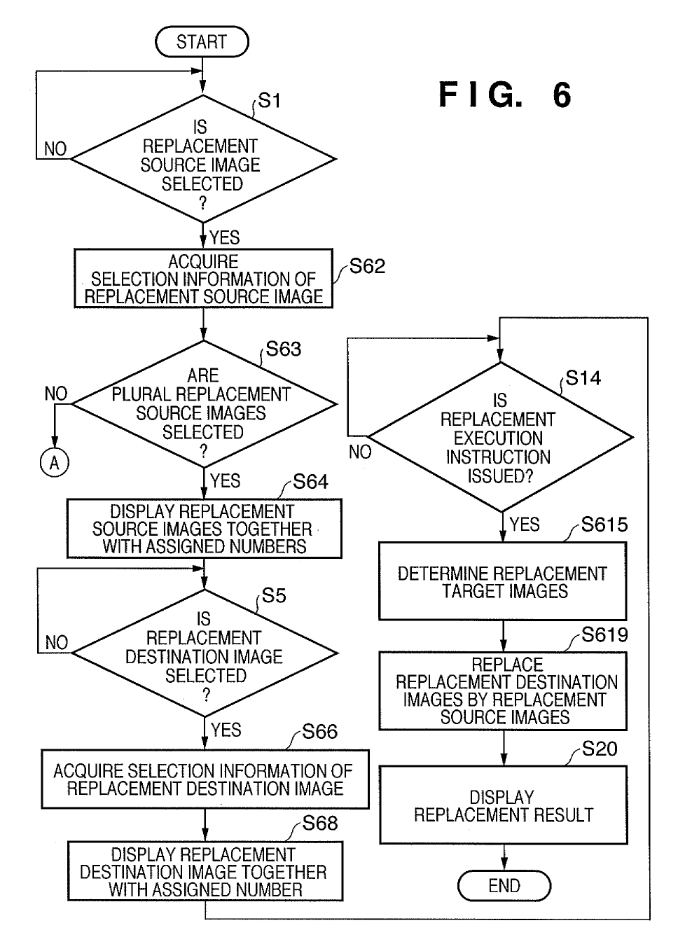

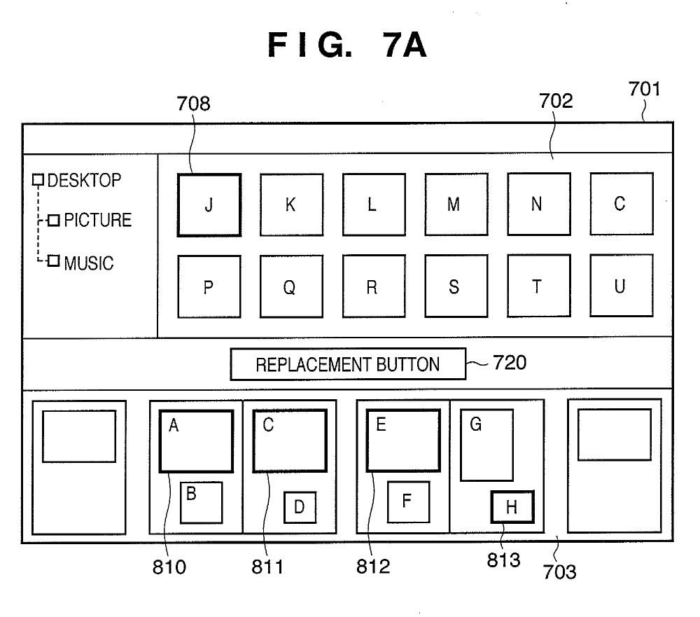

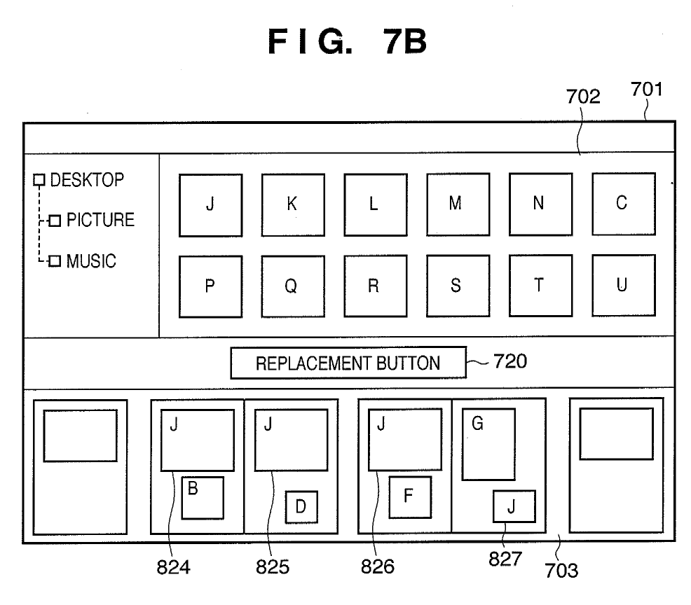

In the operation to be described below, the CPU 201 of the image processing apparatus according to this embodiment replaces images in an electronic album by using the function modules and various types of management information described with reference to FIGS. 3 and 4A to 4C in accordance with the electronic album editing application. This operation will be described with reference to the GUI windows shown in FIGS. 7A and 7B and the flowchart of FIG. 5 which shows the operation procedure of the CPU 201 of the image processing apparatus.

This embodiment exemplifies a case in which a plurality of replacement destination image data are replaced by single replacement source image data.

First of all, in the image processing apparatus according to this embodiment, the electronic album editing application 106 is started on the basis of operation by the user who has used the input unit 205. The user sets the layout of an electronic album by operating the input unit 205. The layout data set in this case includes a paper size, the orientation of the sheet, a background, and the size and position of a frame in which the image is to be inserted. The set layout data is stored as electronic album management data in the HDD 204.

The user selects an image to be edited in the electronic album from the image data stored in the storage area 104 by operating the input unit 205. The stored electronic album management data also includes the file name of the selected image, image data, a file path, or the like. In addition, the stored electronic album management data includes the layout position of each image in the electronic album and a layout size. The stored electronic album management data further includes editing attribute information such as the trimming information of each image and rotation information.

Display data is created on the basis of the electronic album management data. The display control unit 206 then displays an album editing window on the display device 207 on the basis of the display data. The album editing window includes the thumbnails of images contained in the electronic album, buttons for issuing various kinds of editing instructions for the electronic album, and the like.

Subsequently, when the user clicks a button in the album editing window by operating the input unit 205, an instruction to start image replacement is received. In response to this instruction, the display device 207 of the computer 102 displays an image replacement window 701 as a GUI window like that shown in FIG. 7A. In this case, a list of image data existing in the storage area 104 is displayed in an out-of-album image display area (image selection area) 702. On the other hand, in an album editing area (layout area) 703, the image data contained in the electronic album are displayed while being laid out in accordance with the electronic album management data.

The user arbitrarily selects desired replacement source image data from the images displayed in the out-of-album image display area 702 by using the input unit 205 while referring to the image replacement window 701. Similarly, the user arbitrarily selects desired replacement destination image data from the images displayed in the album editing area 703.

FIG. 7A shows a state wherein image data “J” 708 is selected as replacement source image data in the out-of-album image display area 702 in the image replacement window 701.

In addition, in the album editing area 703, image data “A” 810, “C” 811, “E” 812, and “H” 813 are selected as replacement destination image data.

When the user clicks a replacement button 720 with the mouse or the like, the replacement relationship between replacement source image data and replacement destination image data is determined. The image data “A” 810, “C” 811, “E” 812, and “H” 813 are then replaced by the image data “J” 708. As a result of replacement, as shown in FIG. 7B, all image data 824, 825, 826, and 827 are replaced by the image data “J” 708, and the resultant images are displayed by the display device 207.

An operation procedure in the CPU 201 of the image processing apparatus after the reception of the above image replacement start instruction and the display of the image replacement window 701 will be described next with reference to FIG. 5.

First of all, the CPU 201 decides in step S1 whether replacement source image data in the out-of-album image display area 702 in the image replacement window 701 in FIG. 7A is selected.

Assume that in this embodiment, the user has selected the image data “J” 708 as replacement source image data in the out-of-album image display area 702.

The process then shifts to step S2 to acquire the attribute information of the replacement source image data selected in step S1 by using the replacement source image data selection information acquiring unit 306. The attribute information includes information such as a file name and a file path. More specifically, when the user has selected the image data “J” 708 from the out-of-album image display area 702, the display control unit 302 notifies the data control unit 304 of the corresponding information. The data control unit 304 acquires the attribute information of the notified replacement source image data by using the replacement source image data selection information acquiring unit 306, and stores the information as selection information in the replacement source image data selection information storage area 315 of the storage area 104.

In the replacement source image data selection information storage area 315, the selection information of the replacement source image data is stored, as shown in FIG. 4A. More specifically, file name “J” of the image data “J” 708 is registered in the replacement source image data selection information table 401A shown in FIG. 4A.

Assume that in this embodiment, only the image data “J” 708 is selected as replacement source image data. In step S5, the CPU 201 checks whether any replacement source image data has been selected in the album editing area 703.

Assume that in this embodiment, as shown in FIG. 7A, the user has selected a plurality of replacement source image data, i.e., the image data “A” 810, “C” 811, “E” 812, and “H” 813, as replacement destination image data.

In step S6, the CPU 201 acquires attribute information such as the file names of the selected image data, the selection order, and the like by using the replacement destination image data selection information acquiring unit 305. Assume that the file names of the replacement destination image data are uniquely specified in the electronic album. More specifically, when the user has selected the image data “A” 810, “C” 811, “E” 812, and “H” 813 as replacement destination image data from the album editing area 703, the display control unit 302 notifies the data control unit 304 of the corresponding information.

The data control unit 304 acquires the attribute information of the notified replacement destination image data by using the replacement destination image data selection information acquiring unit 305, and stores the acquired information as selection information in the replacement destination image data selection information storage unit 314.

In the replacement destination image data selection information storage unit 314, the selection information of each replacement destination image data is stored, as shown in FIG. 4B. More specifically, the selection information of each replacement destination image data is registered in the replacement destination image data selection information table 401B such that file name “A”, file name “C”, file name “E”, and file name “H” are registered at the first, second, third, and fourth positions, respectively. These pieces of information are registered in accordance with the order in which the image data have been selected in the album editing area 703.

If the selected state of the image data “A” 810 selected in the album editing area 703 is canceled, the data control unit 304 deletes the selection information of the image data “A” 810 from the selection information registered in the replacement destination image data selection information storage unit 314. The CPU 201 then updates the order in which the image data have been selected in the album editing area 703, and stores the selection information such as file name “C”, file name “E”, and file name “H” of the remaining replacement destination image data in accordance with the new order.

The CPU 201 checks in step S14 whether the user has issued a replacement execution instruction by clicking the replacement button 720 using the input unit 205. If the CPU 201 determines that the user has issued the instruction, the process shifts to step S15.

In step S15, the data control unit 304 and the replacement target image data determination unit 307 determine image data as replacement targets by referring to the selection information in the replacement destination image data selection information storage unit 314 and the selection information in the replacement source image data selection information storage area 315. In this embodiment, the image data “A” 810, “C” 811, “E” 812, and “H” 813 as replacement destination image data and the image data “J” 708 as replacement source image data are determined as replacement targets.

In step S19, the data control unit 304 performs a replacement process for the image data determined by the replacement target image data determination unit 307 by using the image data replacement unit 308. More specifically, first of all, file name “A” is read out from the selection information in the replacement destination image data selection information storage unit 314. A search is made for a record having file name “A” from the electronic album management data. The file name of the found record is updated to “J”, and the file path is updated to the file path of the image data “J”. With this operation, the image data “A” is replaced by the image data “J”. Likewise, the image data “C”, “E”, and “H” are replaced by the image data “J”.

In step S20, the updated electronic album management data is read out, and the display data of an image replacement window in which the processing in step S19 is reflected is created. The display data is then sent to the GUI control unit 301.

The GUI control unit 301 causes the display device 207 to display the replacement process result in accordance with the newly acquired display data by using the display control unit 302, as indicated by the image replacement window 701 shown in FIG. 7B.

As described above, according to this embodiment, it is possible to select a plurality of replacement destination image data at once and replace them with one replacement source image data. This can reduce the burden of replacing operation on the user.

### Second Embodiment

This embodiment exemplifies a case in which a plurality of replacement destination image data in an album editing area 703 are respectively replaced by a plurality of replacement source image data in an out-of-album image display area 702.

Note that a description of portions common to the first embodiment will be omitted, and a characteristic portion of the second embodiment will be described in detail, in particular.

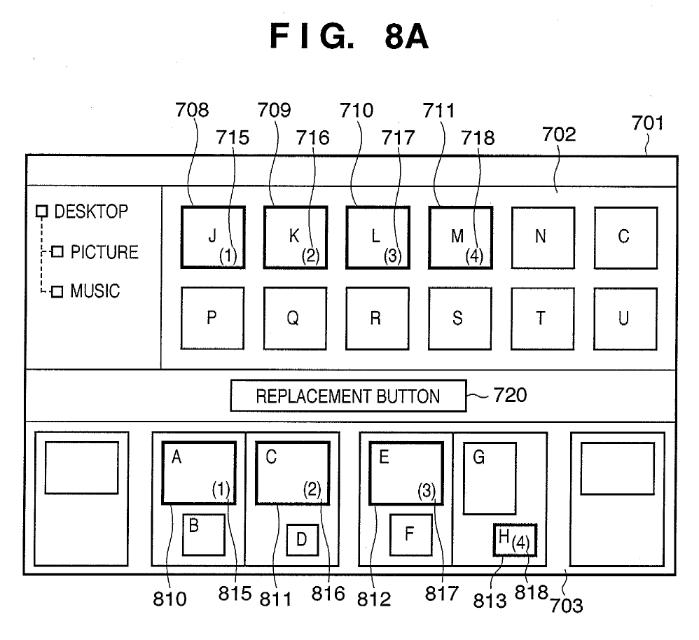

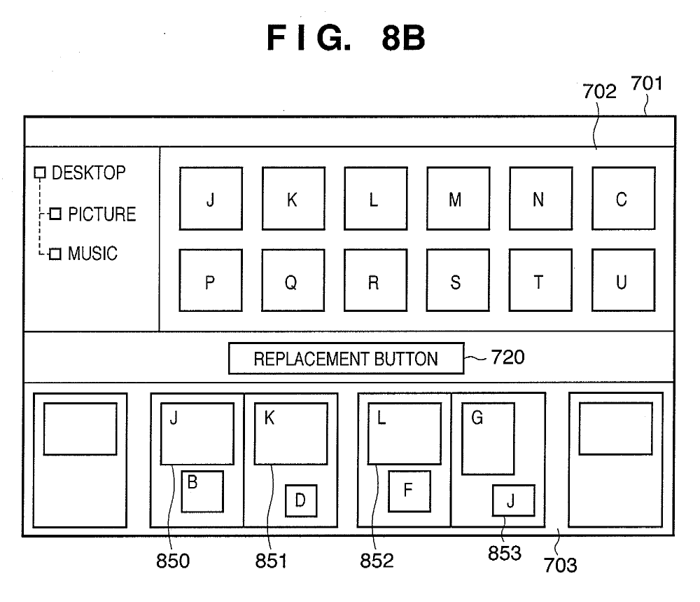

FIG. 8A shows a state wherein in an image replacement window 701, image data “J” 708, “K” 709, “L” 710, and “M” 711 are selected in an arbitrary order as replacement source image data in the out-of-album image display area 702.

In the album editing area 703, image data “A” 810, “C” 811, “E” 812, and “H” 813 are selected in an arbitrary order as replacement destination image data.

The user then clicks a replacement button 720 with a mouse or the like of an input unit 205. As shown in FIG. 8B, the image data “A” 810, “C” 811, “E” 812, and “H” 813 are respectively replaced by the image data “J” 708, “K” 709, “L” 710, and “M” 711 in the order in which the image data have been selected. The display device 207 then displays this result as indicated by reference numerals 850, 851, 852, and 853 in FIG. 8B.

The operation of replacing images in an electronic album, which is executed by a CPU 201 of the image processing apparatus according to this embodiment using the function modules and various types of management information described with reference to FIGS. 3 and 4A to 4C in accordance with an electronic album editing application, will be described below with reference to FIG. 6. Note that the same reference numerals as in FIG. 5 denote the same steps, and a repetitive description will be omitted.

After step S1 in FIG. 5 is executed, selection information of replacement source image data is acquired in step S62 in FIG. 6. In this embodiment, since a plurality of image data are selected from the out-of-album image display area 702 in an arbitrary order, the following information is stored in the replacement source image data selection information storage area 315. More specifically, as the selection information, the order in which replacement source image data have been selected is also acquired as selection information. In accordance with this order, file name “J”, file name “K”, file name “L”, and file name “M” are respectively stored at the first, second, third, and fourth positions in a replacement source image data selection information table 401A. In addition, the respective file paths are also stored.

A data control unit 304 acquires a user definition file area 317 in a storage area 104 by using a number assignment unit 316. The CPU 201 then determines number assignment information in accordance with the number assignment reference (e.g., a selection order, date order, file name order, size order, or solution order) defined in the user definition file area 317. The CPU 201 then issues assigned numbers to the respective replacement source image data, and registers them in the replacement source image data selection information table 401A in a replacement source image data selection information storage area 315.

Assume that in the following description, the number assignment reference defined in the user definition file area 317 is a selection order. The numbers 1 to 4 are respectively assigned to the image data “J”, “K”, “L”, and “M” in accordance with the selection order in the replacement source image data selection information table 401A.

In step S63, the CPU 201 decides whether a plurality of image data have been selected in the out-of-album image display area 702. Upon deciding that a plurality of replacement source image data have been selected, the CPU 201 performs the processing in step S64. Upon deciding that a single replacement source image data has been selected, the CPU 201 executes the same processing as in the first embodiment.

In step S64, as shown in FIG. 8A, a display device 207 displays the respective replacement source image data in the out-of-album image display area 702, together with the assigned numbers registered in the replacement source image data selection information storage area 315.

More specifically, the selection information stored in the replacement source image data selection information storage area 315 is referred to by using a marking unit 312 to acquire the information of assigned numbers and file names in the replacement source image data selection information table 401A.

A GUI control unit 301 then receives an instruction to assign the assigned numbers to the replacement source image data and display them. The GUI control unit 301 performs control to display the image data “J” 708 as replacement source image data, which has already been displayed in the out-of-album image display area 702 upon adding corresponding number information (1) 715 to the image data on the basis of the file name of the image data. Likewise, the GUI control unit 301 performs control to display the image data “K” 709, “L” 710, and “M” 711 upon adding corresponding pieces of number information (2) 716, (3) 717, and (4) 718 to the image data. This operation is executed by using a display management unit 303.

The processing in step S5 in FIG. 5 is executed.

In step S66, the attribute information of replacement destination image data is acquired in the same manner as in step S6 in FIG. 5. In this embodiment, the data control unit 304 issues assigned numbers to the respective replacement destination image data in the order in which the image data have been acquired, and stores them as selection information in a replacement destination image data selection information storage unit 314, together with other pieces of attribute information.

Note that the data control unit 304 acquires the user definition file area 317 in the storage area 104 by using a number assignment unit 316. The data control unit 304 then determines a number assignment method in accordance with the number assignment reference (e.g., a selection order, date order, file name order, size order, or resolution order) defined in the user definition file area 317. Assume that in this embodiment, the number assignment reference defined in the user definition file area 317 is a selection order.

In step S68, the assigned numbers stored in the replacement destination image data selection information storage unit 314 are read out, and the respective replacement destination image data are displayed together with the number information. This display processing is the same as that in the case of the replacement source image data in step S64.

In this manner, replacement source image data and replacement destination image data are displayed upon addition of assigned numbers, and hence the user can easily check which images are replaced by which images.

In step S68, the pieces of information of the file names and their assigned numbers stored in the replacement destination image data selection information storage unit 314 are referred to by using the marking unit 312.

The GUI control unit 301 is instructed to display replacement destination image data together with the information of their assigned numbers. The GUI control unit 301 then displays the image data “A” 810 selected as replacement destination image data in the album editing area 703 upon adding the number information (1) 815 to the data. The GUI control unit 301 displays the image data “C” 811, “E” 812, and “H” 813 upon adding numbers (2) 816, (3) 817, and (4) 818 to the image data. This operation is executed by using the display management unit 303. In this manner, the replacement relationship between replacement source image data and replacement destination image data is determined.

After the processing in step S14 in FIG. 5 is executed, the data control unit 304 reads out the assigned number of replacement destination image data from the replacement destination image data selection information storage unit 314. The data control unit 304 also reads out the assigned number of replacement source image data from the replacement source image data selection information storage area 315. The data control unit 304 then associates image data whose assigned numbers coincide with each other as a replacement pair. For example, the first replacement source image data “J” is associated with the replacement destination image data “A”. Likewise, other images are associated with each other.

If one of the number of replacement destination image data and the number of replacement source image data is larger than the other, the smaller number of image data are repeatedly associated in ascending order.

In step S619, the data control unit 304 performs a replacement process for the associated image data by using an image data replacement unit 308. More specifically, first of all, the data control unit 304 reads out file name “A” from the selection information in the replacement destination image data selection information storage unit 314. The data control unit 304 then searches the electronic album management data for a record having file name “A”. The data control unit 304 updates the file name of the searched-out record to file name “J” of the image data “J” associated with the image data “A”, and also updates the file path to the file path of the image data “J”. Likewise, the data control unit 304 sequentially replaces the remaining images.

When the processing ins step S20 is executed afterward, a window like that shown in FIG. 8B is displayed. That is, this display indicates a state wherein a plurality of image data selected as replacement destination image data in the out-of-album image display area 702 are properly replaced by a plurality of image data selected as replacement source image data in the album editing area 703.

As described above, according to this embodiment, it is possible to select a plurality of replacement destination image data and a plurality of replacement source image data at once and replace them altogether. This makes it possible to reduce the burden of replacing operation on the user.

### Third Embodiment

This embodiment exemplifies a case in which replacement destination image data having editing attribute information are replaced by replacement source image data. Note that a description of portions common to the first and second embodiments will be omitted, and the characteristic content of the third embodiment will be described in detail.

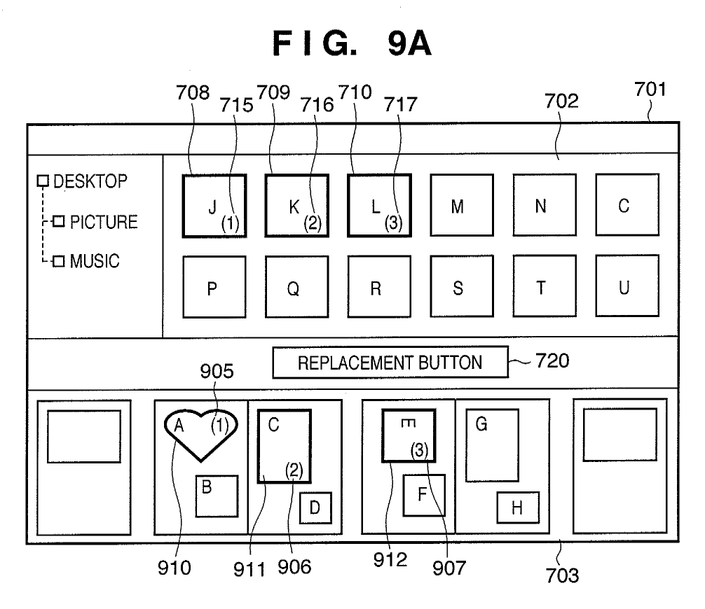

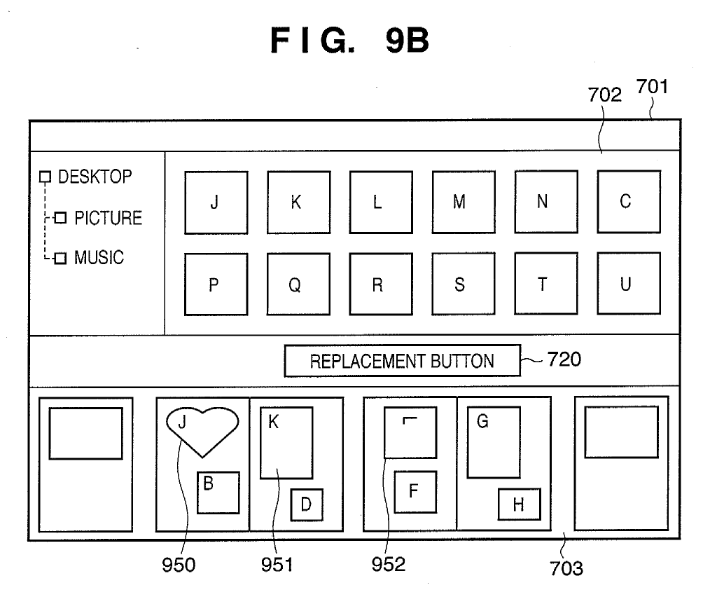

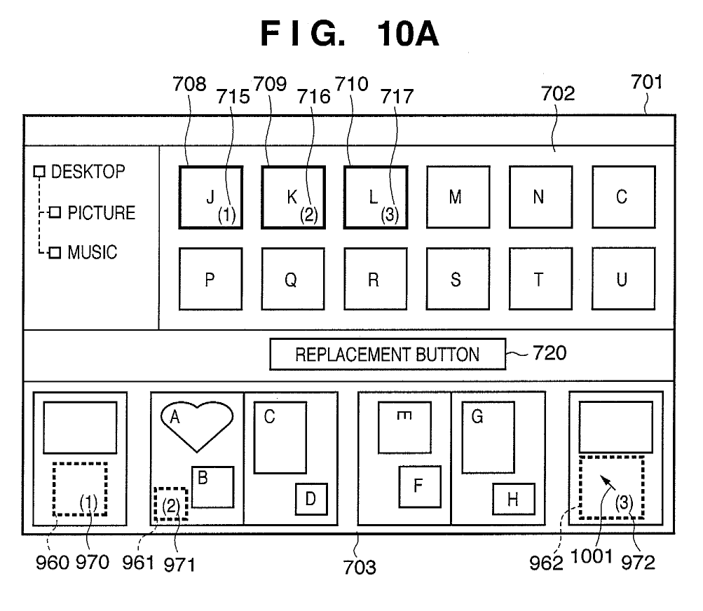

FIG. 9A shows a state wherein image data “J” 708, “K” 709, and “L” 710 are sequentially selected as replacement source image data in an out-of-album image display area 702 in an image replacement window 701.

FIG. 9A also shows a state wherein image data “A” 910, “C” 911, and “E” 912 are sequentially selected as replacement destination image data in the album editing area 703. Further, the image data 910 to 912 are displayed with the selected numbers as indicated by reference numbers 905, 906 and 907.

In this embodiment, as in the second embodiment, the replacement relationship between the replacement source image data and the replacement destination image data is determined on the basis of the order in which they have been selected in this manner.

When the user clicks a replacement button 720 with a mouse or the like, a replacement process is performed for the image data “A” 910, “C” 911, and “E” 912, as shown in FIG. 9B. That is, the image data “A” 910, “C” 911, and “E” 912 are sequentially replaced in the order of image data “J” 950, “K” 951, and “L” 952. In this embodiment, the image data “J” 950, “K” 951, and “L” 952 are displayed in a state wherein the pieces of editing attribute information of the image data “A” 910, “C” 911, and “E” 912 are respectively reflected. That is, the image data “J” is displayed after being trimmed in the shape of a heart in accordance with the editing attribute information which the image data “A” holds. In addition, the image data “L” is displayed while being rotated clockwise through 90° in accordance with the editing attribute information which the image data “E” holds.

The operation of replacing images in an electronic album, which is executed by a CPU 201 of the image processing apparatus according to this embodiment using the function modules and various types of management information described with reference to FIGS. 3 and 4A to 4C in accordance with an electronic album editing application, will be described below with reference to FIG. 11.

In this embodiment, after steps S8, S62 to S64, S5, and S66 are sequentially executed, it is determined whether replacement destination image data includes editing attribute information (step S1109). The image data “A” 910 in FIG. 9A has editing attribute information indicating trimming in the form of a heart. The image data “C” 911 has editing attribute information indicating trimming in a portrait shape. The image data “E” 912 has editing attribute information indicating clockwise 90° rotation.

If the CPU 201 determines in step S1109 that replacement destination image data has editing attribute information, a data control unit 304 acquires the attribute information from the replacement destination image data selected by using an attribute information acquiring unit 309 and stores the editing attribute information in a storage area 104 (step S1110).

For example, as indicated by a replacement destination image data selection information table 401C in FIG. 4C, editing attribute information is stored. More specifically, the table in FIG. 4C has numbers in the selection order, assigned numbers, file names, and editing attribute information. One replacement destination image data may have a plurality of pieces of editing attribute information. File name “A”, editing attribute information 1 “trimming”, and editing attribute information 2 “heart shape” are stored in correspondence with the first replacement destination image data. File name “C”, editing attribute information 1 “trimming”, and editing attribute information 2 “portrait” are stored in correspondence with the second replacement destination image data. File name “E”, editing attribute information 1 “rotation”, and editing attribute information 2 “clockwise 90° rotation” are stored in correspondence with the third replacement destination image data.

After steps S68, S14, and S615, the CPU 201 decides in step S1116 whether editing attribute information is stored in a replacement destination image data selection information table 401. If the CPU 201 determines in step S1116 that the replacement destination image data has editing attribute information, the process shifts to step S1117.

In step S1117, the data control unit 304 reflects the editing attribute information which the image data “A” 910 has in the image data “J” 708 as replacement destination image data by using the attribute information reflecting unit 310. In addition, the data control unit 304 reflects the editing attribute information which the image data “C” 911 has in the image data “K” 709. The data control unit 304 also reflects the editing attribute information which the image data “E” 912 has in the image data “L” 710.

More specifically, the data control unit 304 reflects heart-shaped trimming information which the image data “A” 910 has in the image data “J” 708. The data control unit 304 then reflects the portrait trimming information which the image data “C” 911 has in the image data “K” 709. The data control unit 304 further reflects clockwise 90° rotation information which the image data “E” 912 has in the image data “L” 710. The processing of reflection is to add and store the editing attribute information of associated replacement destination image data to the record of each replacement source image data in a replacement source image data selection information table 401A.

The processing of reflection indicates the following processing executed by the data control unit 304 using an attribute information reflection result storage unit 311. That is, this processing is to add and store the editing attribute information of associated replacement destination image data in the replacement destination image data selection information table 401C to the record of each replacement source image data in the replacement source image data selection information table 401A.

In step S1119, the data control unit 304 performs a replacement process for pairs of image data associated in step S615 by using the image data replacement unit 308. More specifically, first of all, the data control unit 304 reads out file name “A” from the selection information in the replacement destination image data selection information storage unit 314. The data control unit 304 then searches the electronic album management data for a record having file name “A”. The data control unit 304 also reads out the selection information (the file name, file path, or editing attribute information) of the replacement source image data “J” from the replacement source image data selection information storage area 315. The data control unit 304 then updates the file name of the record searched out from the electronic album management data to file name “J”, and the file path to the file path of the image data “J”, and adds editing attribute information. Likewise, the data control unit 304 sequentially replaces the remaining images.

In this embodiment, when the processing in step S20 is executed afterward, the replacement result is displayed such that the pieces of editing attribute information are reflected in the image data 950, 951, and 952 in FIG. 9B.

This embodiment has exemplified the case in which pieces of editing attribute information are stored in the replacement source image data selection information table 401A or a replacement destination image data selection information table 401B and reflected in image data. However, this processing may be omitted.

In this case, the electronic album management data includes the editing attribute information of replacement destination image data in advance. The records of the replacement destination image data found from the electronic album management data can be updated with the selection information of the replacement source image data by not updating the editing attribute information.

It suffices to allow the user to select whether to reflect the editing attribute information of replacement destination image data in the image data after replacement. In this case, this apparatus accepts user's selection whether to reflect the information. A flag representing the content of the selection is stored in advance. After an instruction to execute replacement is received, if it is determined by referring to the flag that the operation of reflecting editing attribute information has been selected, the editing attribute information is not updated when a record of replacement destination image data searched out from the electronic album management data is updated with the selection information of the replacement source image data. If the operation of reflecting no editing attribute information is selected, the editing attribute information of a record of replacement destination image data searched from the electronic album management data is updated with a predetermined initial value or the editing content newly input by the user.

As described above, according to this embodiment, replacement destination image data is replaced by replacement source image data while the editing attribute information of the replacement destination image data is reflected. This makes it unnecessary for the user to execute again the same editing operation as that performed for replacement destination image data with respect to replacement source image data after replacement. This can reduce the burden of replacing operation on the user.

### Fourth Embodiment

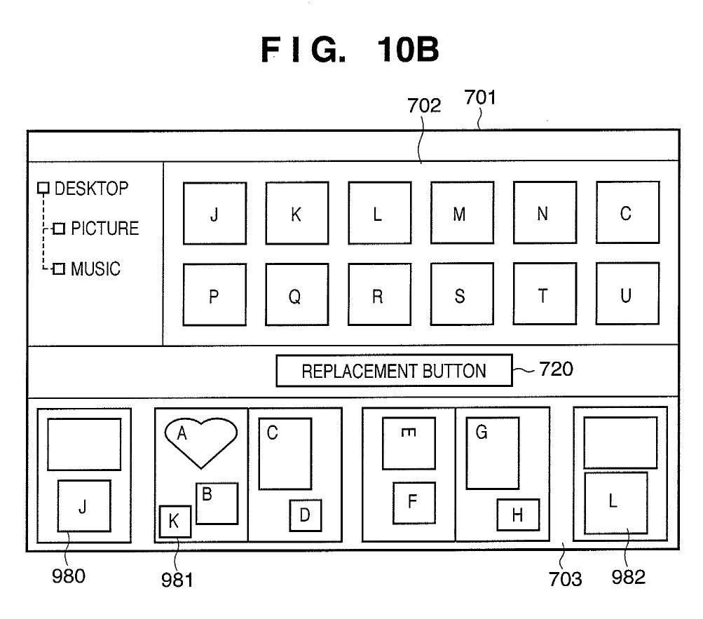

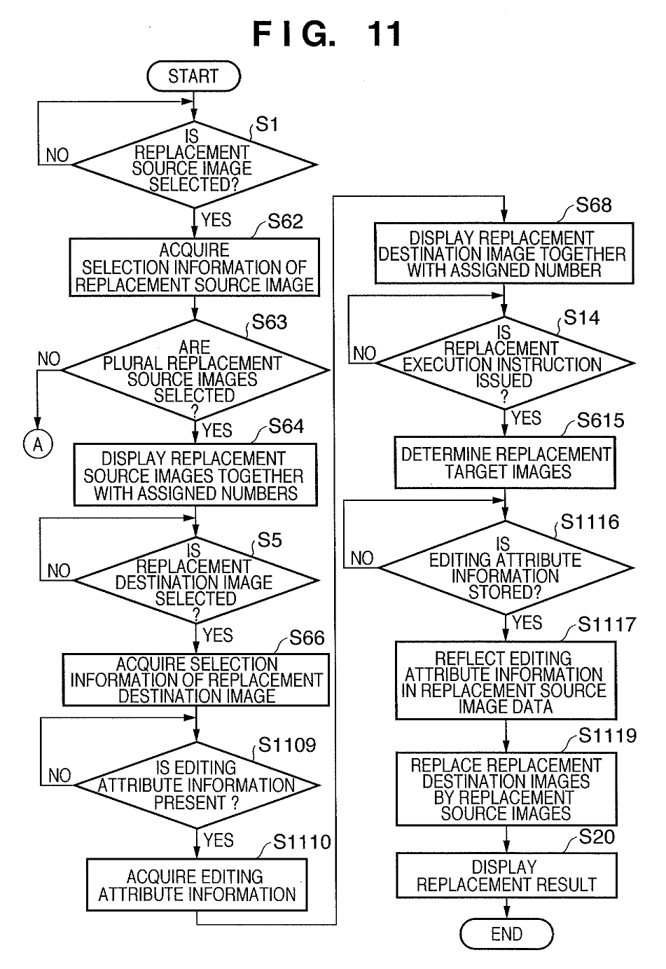

This embodiment exemplifies a case in which areas in an album editing area 703 in which no image data are arranged are filled with a plurality of image data having editing attribute information in an out-of-album image display area 702. This processing will be described with reference to FIGS. 10A and 10B.

Note that a description of portions common to the first to third embodiments will be omitted, and the characteristic content of the fourth embodiment will be described in detail.

First of all, it is checked whether an area in the album editing area 703 in which no image data is arranged has been selected. In the case shown in FIGS. 10A and 10B, areas 960, 961, and 962 in which no image data are arranged have been selected in the album editing area 703. In FIG. 10A, an area of a dotted line frame 962 is selected by the user by designating a position indicated by an arrow 1001 by using a pointing device.

This apparatus then secures the areas in the album editing area 703 which have been selected by the user and in which no image data have been arranged. More specifically, a data control unit 304 acquires image arrangement areas in areas on the same page which do not overlap other image data by using an arrangement area securing unit 313.

This apparatus then performs the processing of explicitly indicating to the user the image data arrangement areas acquired by the arrangement area securing unit 313. More specifically, the data control unit 304 sends the information of the image data arrangement areas acquired by the arrangement area securing unit 313 to a GUI control unit 301, and issues an instruction to display the respective areas with dotted line frames as denoted by reference numerals 960, 961, and 962 in FIGS. 10A and 10B.

The GUI control unit 301 creates frame information by referring to image data arrangement area information by using a display management unit 303 in accordance with this instruction, and causes a display control unit 302 to display the frames.

Subsequently, as shown in FIG. 10B, in response to user's operation, this apparatus can arrange the replacement source image data selected in the out-of-album image display area 702 in the designated places of replacement destination image data as indicated by reference numerals 980, 981, and 982. In addition, it is possible to designate a replacement order by using pieces of order information 715, 716, and 717 and pieces of order information 970, 971, and 972.

Note that in this embodiment, one image data may be stored in a plurality of arrangement areas. That is, the embodiment is not limited to a case in which a plurality of images correspond to a plurality of images.

As described above, according to this embodiment, it is possible to paste arbitrarily designated image data to portions in which no image data are arranged in advance. Note that the first to fourth embodiments of the present invention described above can be executed in combination with each other as needed.

The above embodiment has exemplified the image data. However, embodiments of the present invention can be implemented in the same manner with respect to even the data of various types of objects, e.g., text data indicating a comment, speech data, and graphic data.

As has been described above, according to the above embodiment, when objects such as a plurality of images are to be edited, it is possible to execute a replacement process for the images with simple operation.

Embodiments of the present invention can be implemented even by supplying a storage medium storing software program codes for implementing the functions of the above embodiments to a system or apparatus. That is, the object of the present invention can also be achieved by causing the computer (or a CPU or an MPU) of the system or apparatus to read out and execute the program codes stored in the storage medium.

In this case, the program codes read out from the storage medium implement the functions of the above embodiments by themselves, and the storage medium storing the program codes constitutes the present invention. As a storage medium for supplying the program codes, for example, a flexible disk, hard disk, optical disk, magneto optical disk, CD-ROM, CD-R, magnetic tape, nonvolatile memory card, ROM, or the like can be used.

The functions of the above embodiments are implemented by causing the computer to execute the readout program codes. In addition, the OS running on the computer may perform part or all of actual processing on the basis of the instructions of the program codes. The present invention incorporates a case in which the functions of the above embodiments are implemented by this processing.

In addition, in the present invention, the program codes read out from the storage medium can be executed upon being written in the memory of a function expansion board inserted in the computer or a function expansion unit connected to the computer. Therefore, the present invention incorporates a case in which the CPU or the like of the function expansion board or function expansion unit performs part or all of actual processing on the basis of the instructions of the written program codes, and the functions of the above embodiments are implemented by the processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-022239, filed Jan. 31, 2007, which is hereby incorporated by reference herein in its entirety.

What is claimed is:

1. An image processing apparatus which causes a display device to display image data, the apparatus comprising:
an image selection unit configured to select image data displayed in an image selection area in a first arbitrary order;
a layout position selection unit configured to select layout positions displayed in a layout area in a second arbitrary order;
a determination unit configured to determine layout positions of the image data in the layout area based at least in part upon the first arbitrary order and the second arbitrary order; and
a display control unit configured to control to display the image data selected by the image selection unit at the layout positions determined by the determination unit on the display device.

2. The apparatus according to claim 1, wherein the image data are laid out and displayed at the layout positions in the layout area in advance of selecting by said layout position selection unit.

3. The apparatus according to claim 1, further comprising:
an editing attribute acquiring unit which acquires editing attribute information of the image data displayed in the image selection area; and
an editing unit which edits the image data replaced from the image selection area to the layout area in accordance with the editing attribute information,
wherein the display control unit controls to display an editing result obtained by the editing unit.

4. The apparatus according to claim 3, wherein the editing attribute information is trimming information or rotation information.

5. The apparatus according to claim 1, wherein the first arbitrary order is displayed together with the image data.

6. The apparatus according to claim 1, further comprising a decision unit which decides whether a plurality of the image data have been selected in the image selection area,
wherein the determination unit determines the layout positions when the decision unit decides that the plurality of the image data have been selected.

7. The apparatus according to claim 1, wherein when the image selection unit selects one image data and the layout position selection unit selects a plurality of layout positions, the determination unit determines to set a layout position of the image data selected by the image selection unit to the plurality of layout positions selected by the layout position selection unit.

8. The apparatus according to claim 1, wherein when a number of the image data selected by the image selection unit is different from a number of the layout positions selected by the layout position selection unit, the determination unit determines the layout positions of the image data by repeated selection in ascending order for a smaller one of the number of the image data and the number of layout positions.

9. An image processing method which causes a display device to display image data, the method comprising:
selecting image data displayed in an image selection area in a first arbitrary order;
selecting layout positions displayed in a layout area in a second arbitrary order;
determining layout positions of the image data in the layout area based at least in part upon the first arbitrary order and the second arbitrary order; and
controlling to display on the display device the image data selected in the selecting the image data step at the layout positions determined in the determining step.

10. A computer-readable storage medium which stores a program for causing a computer to execute an image processing method, the method comprising:
selecting image data displayed in an image selection area in a first arbitrary order;
selecting layout positions displayed in a layout area in a second arbitrary order;
determining layout positions of the image data in the layout area based at least in part upon the first arbitrary order and the second arbitrary order; and
controlling to display on the display device the image data selected in the selecting the image data step at the layout positions determined in the determining step.
